(19) United States
(12) Patent Application Publication
(10) Pub. No.: US 2026/0300513 A1
(43) Pub. Date: Oct. 1, 2026

(54) Systems and Methods for Encryption Field Configuration Filters

(71) Applicant: ServiceNow, Inc., Santa Clara, CA (US)

(72) Inventors: Huiqing Wen, San Diego, CA (US); Jiayin Song, Renton, WA (US); Shu-Wei Hsu, San Francisco, CA (US); Pierre Francois Rohel, San Francisco, CA (US); Roopashree Honnashettyhalli Shivanna Gowda, San Diego, CA (US)

(21) Appl. No.: 19/095,727

(22) Filed: Mar. 31, 2025

(51) Int. Cl. G06F 21/60; G06F 21/62

(52) U.S. Cl. CPC G06F 21/602; G06F 21/6227

(57) ABSTRACT

A method includes receiving a dataset that includes a plurality of data entries, determining that a first data entry of the plurality of data entries satisfies a condition associated with a first encryption field configuration (“EFC”) of a plurality of EFCs, where each encryption field configuration defines a condition and one or more first characteristics of encryption when the condition is satisfied, and in response to determining that the first data entry of the plurality of data entries satisfies the condition associated with the first EFC, encrypting the data entry based on the one or more first characteristics of encryption associated with the first EFC.

### TECHNICAL FIELD

The present disclosure relates generally to systems and methods to increase data security, specifically by enabling granular encryption of data values.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Enterprise systems can use databases to store vast amounts of sensitive data. Encryption techniques may be used to secure the sensitive data stored in these databases. Existing techniques for encrypting databases, or tables within databases, typically apply rules for encrypting entire columns within a database. For example, an encryption control module can be used to encrypt a column in the database. In such cases, each entry in the column is encrypted using the same encryption key. Because current column-based encryption techniques treat each data entry in the column uniformly, it may be difficult to enable access to some fields in a column while restricting access to other fields in the same column. This lack of flexibility may lead to the use of one encryption control module for all accessors regardless of a particular accessor's access permissions. Improved systems and methods for encryption are needed to provide more granular control over data encryption.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

In an embodiment, a method includes receiving a dataset that includes a plurality of data entries, determining that a first data entry of the plurality of data entries satisfies a condition associated with a first encryption field configuration (“EFC”) of a plurality of EFCs, where each EFC defines a condition and one or more first characteristics of encryption when the condition is satisfied, and in response to determining that the first data entry of the plurality of data entries satisfies the condition associated with the first EFC, encrypting the data entry based on the one or more first characteristics of encryption associated with the first EFC.

In another embodiment, a system includes a processor, a memory that is accessible by the processing circuitry, and storing instructions that, when executed by the processing circuitry, cause the processing circuitry to execute a client instance, where the client instance is configured to perform operations including: receiving a dataset that includes a plurality of data entries, determining that a first data entry of the plurality of data entries satisfies a condition associated with a first EFC of a plurality of EFCs, where each EFC defines a first condition and one or more first characteristics of encryption when the condition is satisfied, and in response to the determining that the first data entry of the plurality of data entries satisfies the first rule associated with the encryption field configuration, encrypting the first data entry based on the one or more first characteristics of encryption associated with the first EFC.

In a further embodiment, a non-transitory, computer readable medium including instructions that, when executed by processing circuitry, cause the processing circuitry to perform operations including: receiving a dataset that includes a plurality of data entries, determining that a first data entry of the plurality of data entries satisfies a condition associated with a first EFC of a plurality of EFCs, where each EFC defines a first condition and one or more first characteristics of encryption when the condition is satisfied, and in response to the determining that the first data entry of the plurality of data entries satisfies the first rule associated with the encryption field configuration, encrypting the first data entry based on the one or more first characteristics of encryption associated with the first EFC.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present disclosure may operate;

FIG. 2 is a schematic of an embodiment of a multi-instance cloud architecture in which embodiments of the present disclosure may operate;

FIG. 3 is a block diagram of a computing device utilized in a computing system that may be present in FIG. 1 or 2, in accordance with aspects of the present disclosure;

FIG. 4 is a block diagram illustrating a virtual server that supports and enables a client instance configured to manage a database and one or more encryption field configurations (EFCs), in accordance with aspects of the present disclosure;

FIG. 5A is an example of a database table of employee information, which may be stored in the database of FIG. 4, in accordance with aspects of the present disclosure;

FIG. 5B is an example of a table of the EFCs of FIG, 4, corresponding to the enterprise database table of FIG. 5A, in accordance with aspects of the present disclosure;

FIG. 6 is a screenshot of a graphical user interface for defining one of the EFCs of FIG. 4, in accordance with aspects of the present disclosure;

FIG. 7 is a screenshot of a graphical user interface configured to provide an aggregate view of a database table stored in the database of FIG. 4, including at least one predefined EFC of the EFCs of FIG. 4 for the database table, in accordance with aspects of the present disclosure; and

FIG. 8 is an example flow chart depicting a process of granular encryption of data values within the database table stored in the database of FIG. 4 according to EFCs of FIG. 4, in accordance with aspects of the present disclosure.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers'specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

Enterprise systems frequently use databases to store vast amounts of data, some of which may be sensitive data. Encryption techniques may be used to secure the sensitive data stored in these databases. Existing techniques for encrypting databases, or tables within databases, typically utilize column-based encryption by applying rules to encrypt entire columns within a database. Enterprise systems typically do not have the ability to specify an encryption key for certain data values in a data table. However, column-based encryption may not provide sufficient granularity to control access to particular fields within a column. Use of an encryption key restricts the accounts or profiles that can access the sensitive data to those that have the corresponding decryption key. For example, an enterprise system may maintain a data table of information about international employees. Different countries may have different policies on treatment of sensitive data (e.g., salary, social security number, etc.). Using column-based encryption techniques, an entire column of salary information would be encrypted according to a single encryption key. This could be problematic, for example, if a manager is responsible for monitoring certain employee salaries. It may be desirable for the manager to have access to employee salaries in their business unit or country but be restricted from viewing salaries in other business units or countries. In current designs, it may be necessary to use multiple columns (e.g., country or jurisdiction specific columns) to differentially encrypt such data and provide the needed access controls, but such approaches are inefficient in terms of computational resources, such as processing power and memory allotment. Systems and methods for granularly encrypting data based on defined conditions provides a needed improvement in data security.

The present disclosure is directed to systems and methods for encrypting data in a database. Specifically, a computing system may be configured to retrieve encryption field configurations (“EFCs”) associated with different encryption control modules. Each EFC is associated with one or more record conditions that may be defined by one or more filters. If a record condition of an EFC is satisfied for a particular data record (e.g. a row) in a data table, a corresponding data value will be encrypted according to that EFC's encryption control module. Accordingly, multiple EFCs can be defined and applied based on defined conditions/filters and priorities to determine which encryption control module will be applied to a specific data value stored in the data table. Each EFC may be stored in a cache on a server in order of priority to mitigate the risk of applying conflicting encryption control modules to a single data value. Because the priority rules for EFCs may be cached on the server side, encryption requires minimal computational resources and does not increase performance runtime. Existing query functions are then used to populate a table on the server. After the data table has been populated with data, at least one column of the data table may be encrypted according to predefined EFCs. The encryption function traverses the table encrypting each individual data value in the column. After one iteration of the encryption function, the data table may be transmitted to the client device for display. Alternatively, in other embodiments, one or more additional columns in the data table may be encrypted according to the described process.

In some embodiments, a parent EFC may be defined to set a base encryption control module for a column of the data table. Granular EFCs may then be defined to alter the encryption control module for specified fields. In some embodiments, the granular EFCs are layered over the parent EFC such that when a record condition of a granular EFC is satisfied, the encryption control module associated with that EFC will supersede the encryption control module of the parent EFC. If no parent EFC is applied, encryption occurs according to the granular EFCs and some data values may remain unencrypted. Further, a record condition of an EFC may be defined in a foreign location (i.e., the condition triggering the EFC does not have to be in the table being encrypted). In some embodiments, at least one level of dot walking may be used to define EFCs in reference to queries to other datasets in the enterprise system. Accordingly, the disclosed techniques provide a more granular and customizable encryption scheme for a database, resulting in sensitive data being better secured.

In other embodiments, the disclosed techniques may be used in a single EFC use case. In these embodiments, the encryption control module may be defined by the record conditions of a particular EFC. That is, the particular EFC may be associated with a particular column in a data table. The particular EFC may have multiple record conditions that are associated with unique encryption control modules (e.g., encryption keys). In this way, as the record conditions are evaluated (e.g., against filters that make up each record condition) the data value may be encrypted according to the encryption control module of the record condition. If none of the record conditions are satisfied, the data value may remain unencrypted, and an alert may be generated. Alternatively, the data value may be encrypted according to the encryption control module of the particular EFC. In these ways, in the presently described embodiment, the particular EFC may act as the fallback encryption technique, such that the data value will be encrypted according to the encryption control module of the particular EFC if the record conditions of the particular EFC are not satisfied. Thus, each data value in a column may be encrypted granularly and deterministically according to multiple record conditions associated with one EFC.

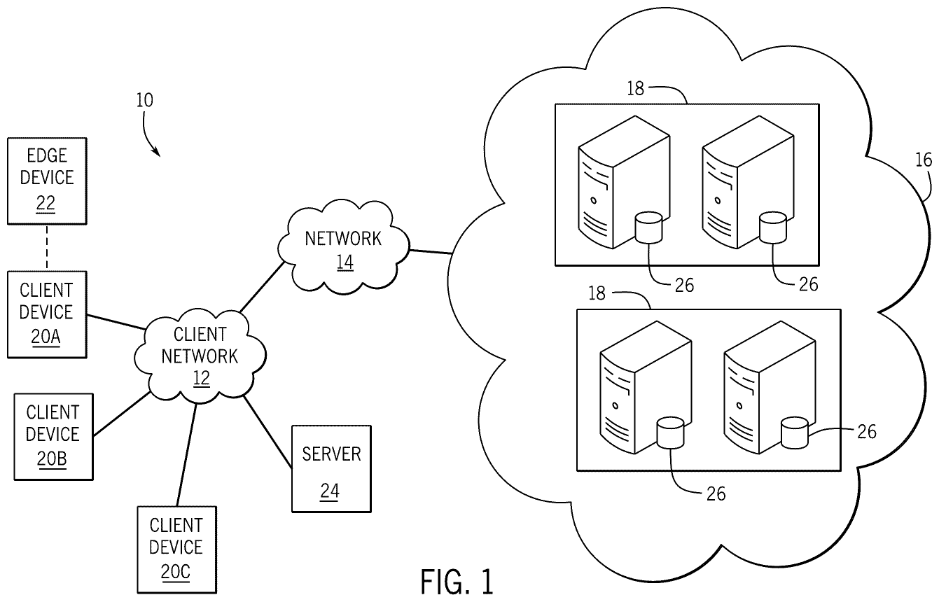

With the preceding in mind, the following figures relate to various types of generalized system architectures or configurations that may be employed to provide services to an organization for which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, 20B, and 20C so that the client devices are able to communicate with each other and/or with the network hosting the platform 16. The client devices 20A, 20B, 20C may be computing systems and/or other types of computing devices that access cloud computing services, for example, via a web browser application or via an edge device 22 that may act as a gateway between the client devices 20A, 20B, 20C and the platform 16. FIG. 1 also illustrates that the client network 12 includes an administration or managerial application, device, agent, or server, such as a server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20A, 20B, 20C and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20A, 20B, 20C via the client network 12 and network 14. The network hosting the platform 16 provides additional computing resources to the client devices 20A, 20B, 20C and/or the client network 12. For example, by utilizing the network hosting the platform 16, users of the client devices 20A, 20B, 20C are able to build and execute applications and/or workflows for various enterprise, IT, and/or other organization-related functions. In one embodiment, the network hosting the platform 16 is implemented on the one or more data centers 18, where each data center could correspond to a different geographic location. Each of the data centers 18 includes a plurality of virtual servers 26 (also referred to herein as application nodes, application servers, virtual server instances, application instances, or application server instances), where each virtual server 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

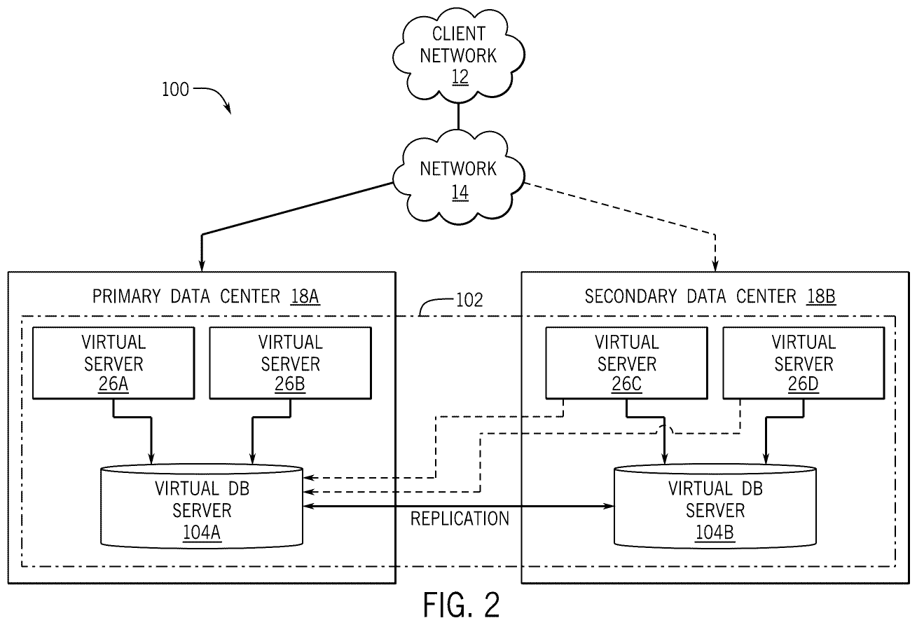

In another embodiment, one or more of the data centers 18 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another and provide data replication and/or failover capabilities. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, this disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, edge devices, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

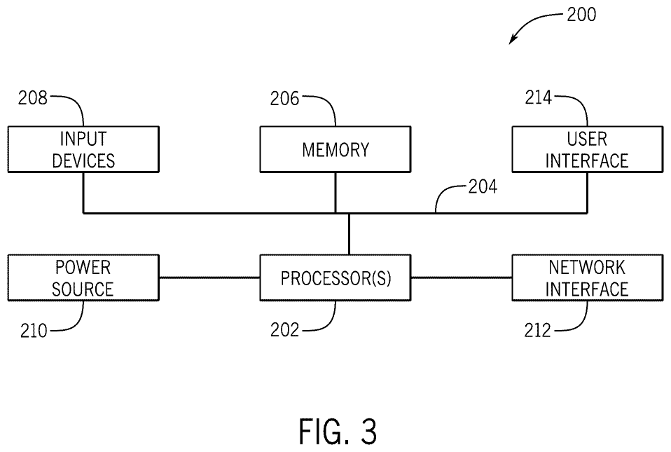

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computing system 200 may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202 (e.g., processing circuitry), one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202.

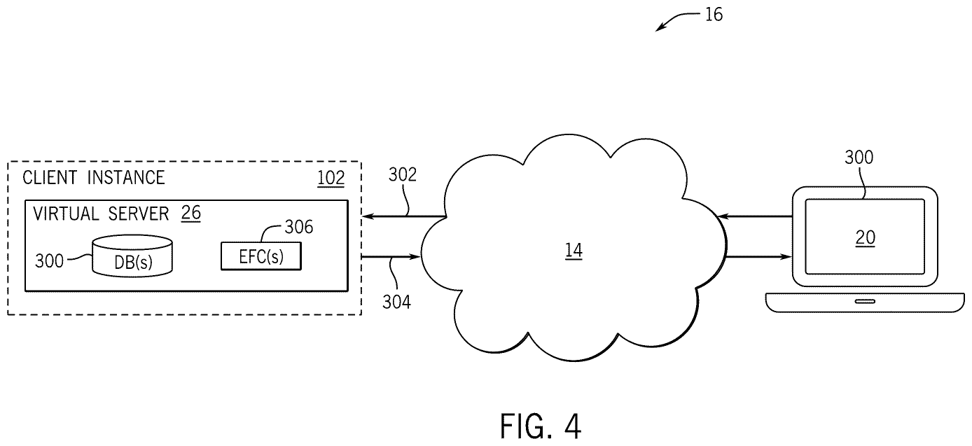

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to a client device 20 via the network 14 to provide a user interface to network applications executing within the client instance 102 (e.g., via a web browser or a native application running on the client device 20). Client instance 102 is supported by virtual servers 26 similar to those explained with respect to FIG. 2, and is illustrated here to show support for the disclosed functionality described herein within the client instance 102. Cloud provider infrastructures are generally configured to support a plurality of end-user devices, such as client device(s) 20, concurrently, wherein each end-user device is in communication with the single client instance 102. Also, cloud provider infrastructures may be configured to support any number of client instances, such as client instance 102, concurrently, with each of the instances in communication with one or more end-user devices. As mentioned above, an end-user may also interface with the client instance 102 using an application and/or a web browser.

As shown in FIG. 4, virtual server 26 may host or otherwise have access to one or more databases 300, which may include one or more database tables for storing various types of data (e.g., employee data, customer data, vendor data, procurement data, accounting data, asset data, information technology (IT) data, product data, and so forth). The virtual server 26 may receive inputs 302 from the client device 20, which may include, for example, requests for the virtual server 26 to perform various operations on the databases 300. For example, the inputs 302 may include requests to retrieve one or more records from the database 300, modify records stored in the database 300, add records to the database, and so forth. The virtual server 26 may generate outputs 304 to be transmitted back to the client device. The outputs may include, for example, data from records retrieved from the database 300, confirmation that requested operations have been performed, and so forth. In some embodiments, the databases 300 are configured to store encrypted data. In such embodiments the virtual server 26 may use one or more encryption field configurations (EFCs) to manage encryption of data stored in the database 300.

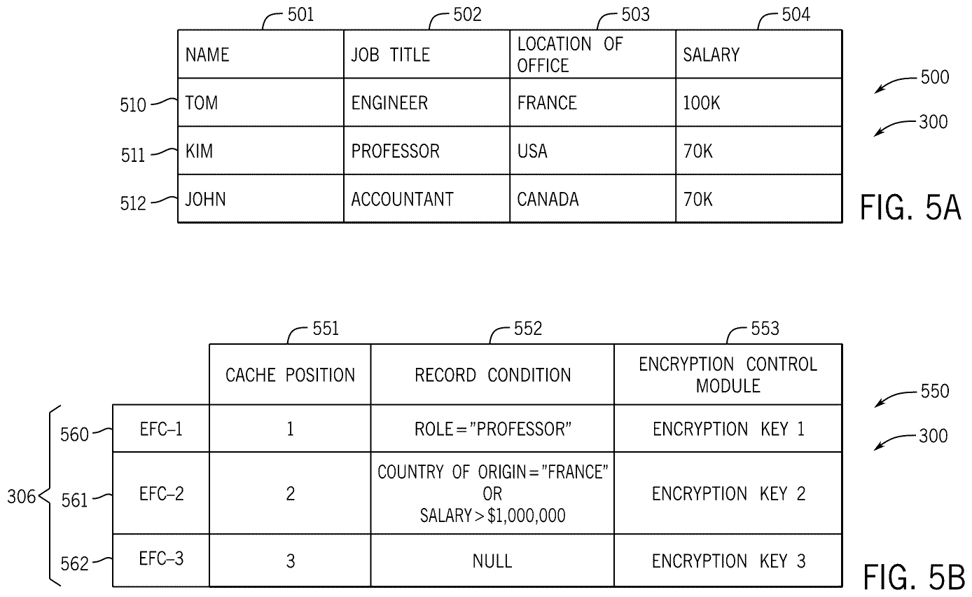

By way of example, FIG. 5A represents a sample database table 500 that may exist in the database 300. Following the introductory example, the enterprise database table 500 stores information about international employees. For example, Tom is an engineer in France with a salary of $100,000, Kim is a professor in the United States with a salary of $70,000, and John is an accountant in Canada with a salary of $70,000. By using column-based encryption techniques to encrypt the database table, entire columns of the database table 500 may be encrypted using a single encryption key, meaning that a profile that has access to the encryption key may have access the entire column of the table 500. However, the enterprise may wish to provide more granular access to the database table 500 by providing a profile with access to some of the fields in the column (e.g., only access salary data for employees in certain roles or located in certain countries). Using EFCs, however, the salary column may be encrypted deterministically. The enterprise may define a Module Access Policy (MAP) for specifying the users who are authorized to decrypt and view certain data values (e.g., by providing encryption keys that are associated with the encryption control modules of the EFCs) and the users who are unauthorized from decrypting and viewing certain data values.

In the instant example, the database table 500 includes records having data fields in multiple columns 501, 502, 503, 504. The first column 501 stores the names for employees within the enterprise. The second column 502 stores the job title of each employee. The third column 503 stores the country of the office location in which each employee works. The fourth column 504 stores the salary of each employee. Likewise, the rows 510, 511, 512 of the database table 500 represent the data records. Each record may be viewed as a complete or partially complete row of data values in the database table 500. For example, the first record 510 identifies Tom as an engineer in France with a $100,000 salary. Thus, in FIG. 5A, each data record includes four data values for each employee. It should be understood, however, that the database table 500 shown in FIG. 5A is an example that has been simplified for illustrative purposes. Accordingly, embodiments are envisaged in which the database table 500 includes more (or fewer) records, and/or more (or fewer) fields. Further, the data stored in the database table 500 on FIG. 5A has been simplified for illustrative purposes. Accordingly, embodiments are envisaged in which the database table 500 stores other types of data.

With the foregoing in mind, FIG. 5B represents an EFC table 550, which may be stored in the one of the databases 300 of FIG. 4, and includes records for three EFCs 306, including EFC-1 560, EFC-2 561, and EFC-3 562. Each EFC 306 record may include a cache position 551, one or more record conditions 552, and an encryption control module 553. The cache position 551 may provide the priority of the respective EFC 306. Each EFC may be assigned a cache position 551 to improve encryption efficiency and mitigate against the risk that one data value will be encrypted according to multiple encryption control modules 553. For example, EFC-1 560 is in the first cache position and, therefore, has the highest priority whereas EFC-3 562 has the lowest priority. The record condition 552 may include one or more filters for determining whether to apply the respective encryption control module 553 of an EFC to a data value within a data record. A filter may be, for example, a number value being over a threshold, string comparison function, a condition being true or false, or any other comparative function. Further, a record condition 552 may consist of multiple filters combined with logic operators (e.g., Boolean operators). For example, if the record condition 552 of an EFC 306 is satisfied for a data record, then the encryption control module 553 of the EFC 306 may be applied to encrypt a data value within the data record. The encryption control module 553 is the encryption key to be used to encrypt the data value within the data record. In the provided example table 550, each EFC 560, 561, 562 is associated with a distinct encryption control module 553. For example, if the record condition 552 for EFC-1 560 is satisfied, then the associated data value may be encrypted with Encryption Key 1.

The EFC table 550 of FIG. 5B may be applied to the enterprise database table 500 of FIG. 5A to encrypt data stored in the database table 500 (e.g., the employee salary information). The client instance may receive the first data record 510 from the enterprise database table 500, or from some other source, such as a client device, third-party software product, etc. The client instance may pull the first EFC, EFC-1 560, from the first position in the cache 551. The record condition 552 of EFC-1 560 may be evaluated against the first data record 510. Because the job title 502 of data record 510 does not match the record condition 552 of EFC-1 560, the encryption control module 553 of EFC-1 560 is not applied to the salary field 504 of the first data record 510. Therefore, the client instance may pull the next EFC, EFC-2 561, from the second position in the cache 551. Similarly, the record condition 552 of EFC-2 561 may be evaluated against the first data record 510. Because the office location 503 of data record 510 satisfies the first filter of the record condition 552 of EFC-2 561, the encryption control module 553 of EFC-2 561 is applied to the salary field 504 of the first data record 510. Thus, the salary field 504 of the first data record 510 is encrypted with Encryption Key Two (i.e., EFC-2).

Continuing with the example, after encrypting the first data record 510, the client instance retrieves the second data record 511 (e.g., from the enterprise database table 500, a client device, a third party, etc.). Because the job title 502 of the second data record 511 satisfies the record condition 552 of EFC-1 560, the salary field 504 of the second data record 511 may be encrypted with Encryption Key One (i.e., EFC-1). Regarding the third data record 512, neither the record condition 552 of EFC-1 560 nor the record condition 552 of EFC-2 561 are satisfied. The record condition 552 of EFC-3 562 is null. Thus, any data record that does not satisfy the one or more record conditions 552 of any other EFC may be encrypted according to the encryption control module 553 of EFC-3 562. For example, the salary field 504 of the third data record 512 may be encrypted with Encryption Key Three (i.e., EFC-3). As described in more detail herein, EFC-3 562 may be described as a parent encryption field configuration in some embodiments. Accordingly, EFC-3 562 may provide column-based encryption if no other EFCs 306 apply (e.g., no record conditions 552 are met).

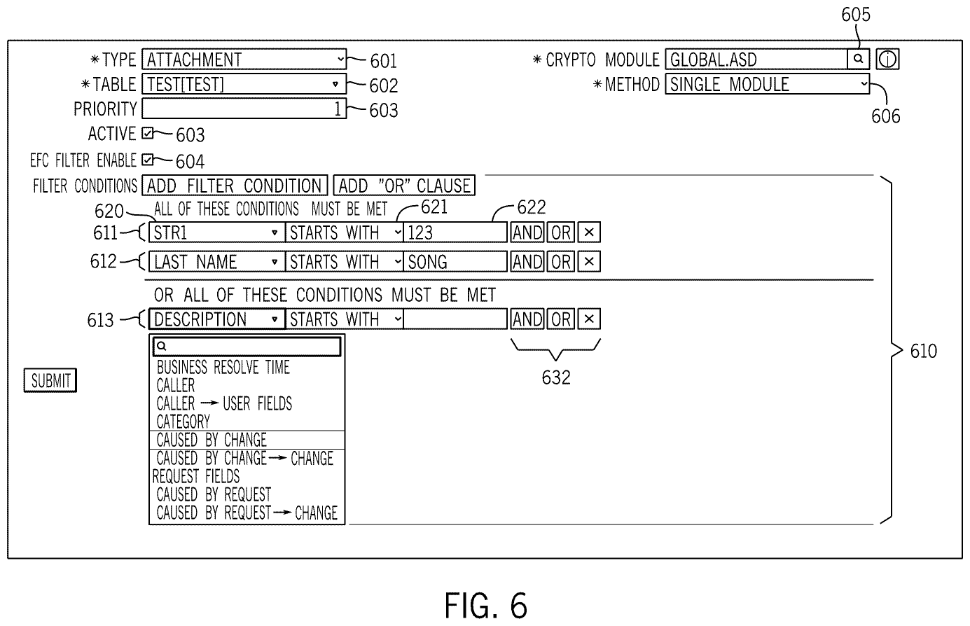

FIG. 6 demonstrates a sample graphical user interface 600 for defining EFCs. For example, the graphical user interface 600 may receive or otherwise facilitate selection and/or entry of inputs defining an EFC. In this example, inputs provided to an EFC type field 601 select a type for the EFC (e.g., from a drop-down menu). Though an attachment type EFC has been selected, it should be understood that embodiments are envisaged in which other EFC types are selected. A table field 602 may be configured to receive inputs selecting database tables 602 to which the EFC applies. A priority field 603 receives inputs specifying a priority for the EFC relative to other EFCs (e.g., the cache position described with regard to FIGS. 5A and 5B). The priority 603 of the EFC defines the order in which it will be evaluated. For example, although the record conditions of multiple EFCs might be satisfied for a data record, conflicts do not occur because after a record condition of the EFC is satisfied, the corresponding data value is encrypted, and the encryption process continues with the next data record in the database table 602. In some embodiments, the priority 603 for an EFC may automatically adjust (e.g., raise or lower) the priority 603 of previously defined EFCs. Moreover, in other embodiments, a priority 603 may be blocked or inaccessible to the database administrator if that priority 603 has been assigned to another EFC. In some embodiments, an alert may be generated if a user (e.g., a security administrator) attempts to define conflicting EFCs. For example, a push notification may be transmitted to the or a GUI indication may be provided specifying the conflicting EFCs. The alert may include a suggested priority 603 to mitigate the risk of multiple EFCs having conflicting priorities 603.

An active checkbox may be selected or deselected to indicate whether the EFC is active or inactive. An EFC filter enable checkbox 604 indicates whether EFC filtering, as described above with regard to FIGS. 5A and 5B, is enabled or disabled. An encryption control module field 605 for the EFC receives inputs identifying an encryption key that will be associated with the EFC. In some embodiments, the same encryption control module 605 may be applied to multiple EFCs. The method field 606 receives inputs specifying whether the EFC will apply a single encryption module or multiple encryption modules.

In some embodiments, the GUI 600 may also be configured to receive inputs defining one or more record conditions 610. In this depiction, one record condition 610 is presented, however, it is envisaged that multiple record conditions 610 may be defined for one EFC. The record conditions 610 may contain one or more filters 611, 612, 613. Each filter may be broken into various components. In the example shown in FIG. 6, each filter contains a field 620, condition 621, and test value 622. The field 620 refers to a data field of a data table. For example, the job title column 502 in FIG. 5A may be considered a field 620. The field 620 may reference one or more fields in the table 602 being encrypted, a data field located on a different data table on the enterprise network, or a data field located in a foreign data set (e.g., a data table on a separate network). The condition 621 is any possible operation that can be evaluated on a computing system. For example, the condition 621 of filter 611 is whether a string “starts with” certain characters. Likewise, the condition 621, may be a numerical calculation, whether a data value exists for a certain field 620, a comparison of a certain field 620, or any other conditional statement. The test value 622 may be any data value or data type that the condition 621 can be evaluated against. The test value 622 of filter 611, for example, is “123.” Thus, in the instant example, if a data value in field 620 satisfies the condition 621 of starting with test value 622 “123” then the filter is satisfied.

Further, the record condition 610 may include filters that reference the account, device, profile, or viewer accessing the data table. For example, the field 620 of a filter may be directed at a data table holding information about profiles on an enterprise network. Likewise, the condition 621 may reference whether a job title or clearance level associated with an accessor matches or supersedes (e.g., according to a corporate hierarchy) a test value 622. In these embodiments, the EFC may encrypt the data table according to the accessor's permissions. By way of example, in some enterprise systems it may be desirable for some accounts (e.g., accountants) to access certain sensitive data (e.g., social security numbers) while other accounts on the same enterprise network (e.g., technology support staff) do not need access to that sensitive data. Correspondingly, the accounts belonging to technology support staff may have access to certain sensitive data (e.g., login credentials) that accounts belonging to accountants cannot access. The record condition 610 can be configured to reference a field 620 associated with the accessing account and the conditional 621 and test value 622 may be defined to encrypt data values because of characteristics associated with the accessing account. Accordingly, many accounts, devices, profiles, or viewers may have access to the encrypted data table with only certain accounts, devices, profiles, or viewers being able to decrypt subsets of sensitive data on the data table.

In some embodiments, as depicted in FIG. 6, a record condition 610 may contain more than one filter. For example, the record condition 610 is not satisfied unless both filter 611 and filter 612 are satisfied or filter 613 is satisfied. The graphical user interface 600 enabled the inclusion of Boolean operations to control the filters with the “add filter condition” button 630 and the “add ‘OR’ clause” button 631. The record condition 610 is configured to provide even more flexibility with additional operations 632. The additional operations 632 may include, deleting a filter, adding an AND operation to a filter, or adding an OR operation to the filter. The additional operations 632 may provide further utility over the “add filter condition” button 630 and the “add ‘OR’ clause” button 631 because Boolean operators may be embedded to create a more advanced and/or complex record condition 610. For example, the following record conditions 610, each separated by a semi-colon, represent possible filter configurations (wherein F1, F2, and F3 are filters): (F1 and F2) or F3; F1 and (F2 or F3); F1 or F2 or F3).

In some embodiments, restrictions may be placed on the users that can define or edit filters. For example, users who are unauthorized to access or view encrypted data (e.g., according to a Module Access Policies (MAP) defined by a security administrator) may be unable to define, edit, or delete EFCs, including the embedded record conditions and/or filters to remove restrictions on their ability to access or view data. Further, unauthorized users may be prevented from circumventing encryption rules by defining superseding EFCs that may be accessible according to the designated permissions and encryption keys provided to the unauthorized users. The unauthorized users may be restricted from deleting or updating encrypted data values. That is, the unauthorized user may be able to see the encrypted column and edit certain data values in the column (e.g., data values that are unencrypted or that the user has access to according to the MAP), but may not be able to view or edit data values that are encrypted and not accessible according to their permissions. Further, in some embodiments, unauthorized users may be able to write data (e.g., insert data) to a data table, but will not be able to see or edit the data after it has been encrypted.

Although the example shown here depicts one record condition 610, additional record conditions 610 may be defined for an EFC. For example, in some embodiments, the additional record conditions 610 may be defined and provided a priority (e.g., a priority assigned by a security administrator). That is, a first record condition 610 may be assigned a higher priority than a second record condition 610 and, therefore, be evaluated before the second record condition. Multiple record conditions 610 may be associated with different encryption control module fields 605 and different encryption keys. This may further promote the ability to deterministically select encryption keys for data values in a column.

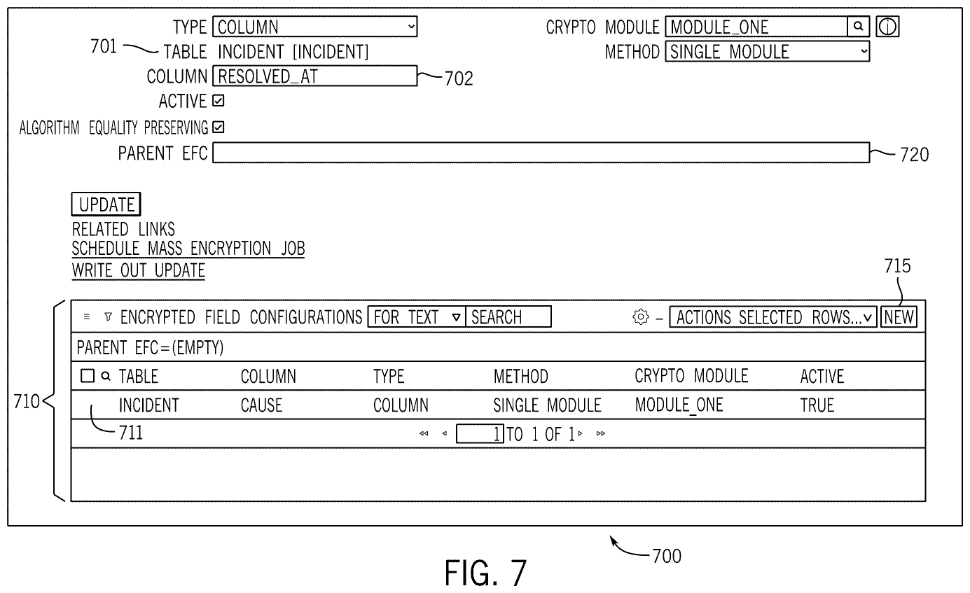

FIG. 7 provides a depiction of a graphical user interface 700 configured to provide an aggregate view of EFCs for a data table 701. The graphical user interface 700 may receive an input selecting a column 702 to view the defined EFCs associated with that column 702. For example, the salary field 504 of FIG. 5A could be selected as the column 702. The EFCs associated with the column 702 may be presented in a panel 710. The panel 710 may display one or more defined EFCs 711. In some embodiments, the EFCs 711 may be displayed in the panel 710 according to their priority. Critical information about the EFCs 711 may also be displayed in the panel 710 (e.g., the associated encryption control module, the record conditions defined with the EFC, whether the EFC is active, the column the EFC is applied to, or any other property of the EFC). The “new” button 715 of the panel 710, upon selection, may be configured to open the graphical user interface 600 of FIG. 6, which is configured to receive inputs defining a new EFC.

In some embodiments, inputs may define a parent EFC 720. A parent EFC 720 has a record condition that encrypts each data value in a column. For example, the record condition of a parent EFC may be blank. A parent EFC 720 may be configured to have a higher priority (e.g., the parent EFC is located in a first cache position and each data value in a column is initially encrypted according to the encryption control module of the parent EFC with additional granular EFCs layered over the parent EFC to replace the encryption control module of the parent EFC) or the parent EFC 720 may be configured to have a lower priority (e.g., the parent EFC acts as a catch all by encrypting all data values that did not meet a record condition of any EFCs with a higher priority). In other embodiments, such as single EFC use cases where multiple record conditions are used to define the encryption control module that is applied to a data value, the EFC may act as a parent encryption mechanism. That is, if none of the record conditions are satisfied, the encryption control module of the EFC may be applied to the data value.

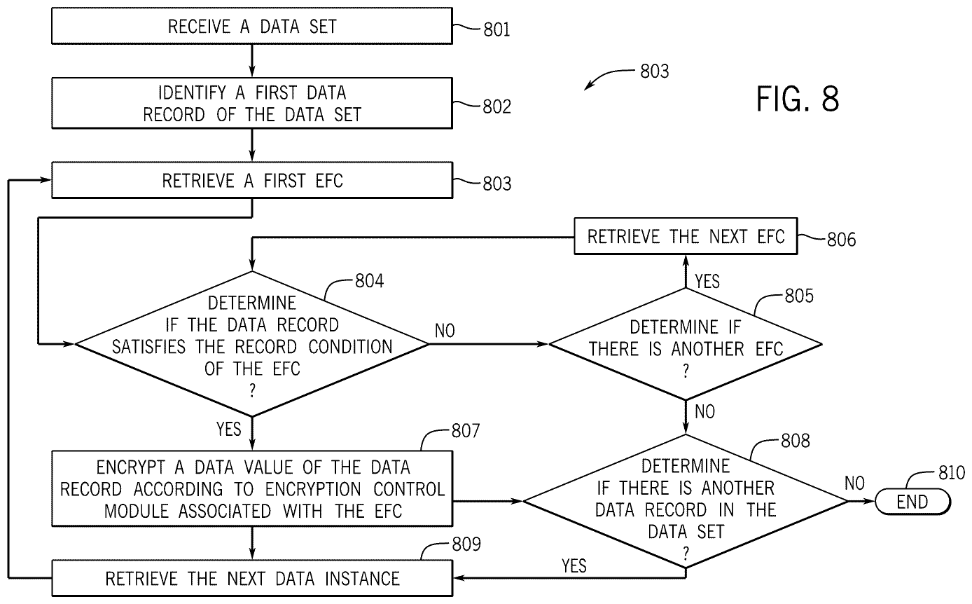

With the foregoing examples in mind, FIG. 8 provides an example flowchart of a sample embodiment depicting a method 800 for encrypting data values using EFCs. Although the following description of the method 800 is described as being performed by a computing system, it should be noted that any suitable system capable of processing data may perform the method 800 described herein. In addition, although the method 800 is described in a particular order, it should be understood that the method 800 may be performed in any suitable order and may exclude one or more of the blocks described herein.

At block 801, a computing system receives a data set (e.g., a data table, data records, pieces of data, etc.). The data set may be any virtual structure capable of holding data (e.g., a SQL table, a NoSQL table, a CloudTable, a multidimensional array, a data record, etc.). The data set may be retrieved from an internal or external database and/or table, may be received from a client device, may be retrieved from a third party (e.g., a third-party platform, software product, service provider, etc.).

At block 802, the computing system identifies the first data record in the data set. The data record may be a collection of one or more data values associated with one another. For example, if the data set is a data table, the data record may be one row in the data table.

At block 803, the computing system retrieves a first EFC. EFCs may be stored in, for example, allocated memory in the cache. In some embodiments, the first EFC will be located in the first allocated memory position in the cache. As described above, caching EFCs in order of priority improves efficiency. Moreover, intentionally caching EFCs may prevent errors where multiple encryption control modules are applied to a single data value. In some embodiments, the first EFC may be a parent EFC to initially encrypt each data value in a column with a common encryption control module.

At block 804, the computing system determines whether the data record satisfies one or more record conditions associated with first EFC. The one or more record conditions may include one or more filters. In some embodiments, the filters may be combined with Boolean operators to promote specific tailoring of the record conditions to more defined criteria. In some embodiments, the filters may be configured to determine whether a profile (e.g., the account attempting to view the data set) has access permissions for the data set. In other embodiments, the filters may be evaluated against other data values in the same data record. Further, in other embodiments, the filters may be evaluated against queries to additional data sets. In some embodiments, some EFCs may be parent EFCs with a record condition that contains no filters or null filters. In those cases, each data value in a column may be encrypted uniformly.

If the first EFC's record condition is not satisfied, the computing system proceeds to block 805. At block 805, the computing system determines whether another EFC has been defined. In some embodiments, the next EFC will be located in the allocated memory position directly following the preceding EFC. If there is another EFC, the computing system retrieves the next EFC at step 806 and then returns to block 804 to determine if the data record satisfies the record condition of the next available EFC. Where multiple EFCs are defined, the process may loop until either a record condition is satisfied or there are no remaining EFCs.

Conversely, if at block 804 a record condition for an EFC is satisfied, the computing system moves to step 807. At step 807, at least one data value (e.g., a data value corresponding to one field or column) of the data record is encrypted. The encrypted data value may be an entry in a standard data format (e.g., a string, an integer). Alternatively, in some embodiments, the encrypted data value may refer to an attachment (e.g., a file, a hyperlink) that is stored in the data record. The computing system encrypts the data value according to an encryption control module of the EFC whose record condition was satisfied. Alternatively, in embodiments where multiple record conditions are defined for one EFC, the data value may be encrypted according to the encryption control module associated with the highest priority record condition whose filters were satisfied. Therefore, each data value may be encrypted according to a determinable encryption key. Some accounts, profilers, or accessors may have the decryption privileges (e.g., according to the Module Access Policies (MAP) for the enterprise or organization associated with the data set) for certain encryption control modules and lack the ability to decrypt other encryption control modules. Resultingly, encrypting a data set with granular EFCs provides significant advantages to encrypting data sets where, for example, some accessors are permitted to see some, but not all, information in the data set. This improvement allows enterprise systems to store data centrally (e.g., in one data set) without sacrificing data security or ease of access for permitted viewers.

After the data value of the data record is encrypted the computing system may move to step 808. Similarly, if the data value of the data record remains unencrypted because it failed to meet the record conditions of any of the defined EFCs, the computing system may also continue to step 808. In some embodiments, if a data value remains unencrypted, an alert may be generated. For example, a push notification may be transmitted to a security administrator, or a GUI indication may be provided specifying the data value that is unencrypted. At step 808, the computing system determines if there is another data record in the data set. If there is, the computing system retrieves the next instance (block 809) and the first EFC (block 803). The process is then repeated until there are no remaining data records in the data set.

At block 810, the computing system may terminate the encryption method, and the data set may be stored in memory, transmitted to a client device, transmitted to a third-party platform, software, or service, and so forth. Alternatively, the encryption process may be repeated with another set of EFCs for a different column in the data set.

In some embodiments, when data records are changed, the process described herein may be reinitiated. For example, referring briefly to FIG. 5B, if the salary field 504 is the encrypted data field and the salary value for one of the data records (e.g., data record 510 referring to Tom) is changed, the updated salary value may be automatically re-encrypted. Conversely, if the data records that impact an encrypted data value are updated, in some embodiments, the encrypted data value may not be automatically re-encrypted. For example, if the record condition and/or filter that triggers encryption for the salary field 504 is associated with the office location 503 of the data record, the salary field 504 for the first data record (e.g., data record 510 referring to Tom) may not be automatically re-encrypted in response to a change of his office location 503 (e.g., from France to Australia). That is, an encrypted data value may be re-encrypted automatically in response to updating the encrypted data value, but the encrypted data values may not be automatically re-encrypted if other changes to the dataset affect the record conditions and/or filters defining the encryption control module for the encrypted data value.

In some embodiments, batch encryption processes may be scheduled to check and re-encrypt the dataset (or a subset of the dataset corresponding to the data records that have been changed, added, or deleted). In these embodiments, the computing system may reinitiate the method 800 at a scheduled time to re-encrypt the entire dataset or the desired subset of data records and data values. Alternatively, the data set may be automatically checked and re-encrypted periodically (e.g., hourly, daily, weekly). A security administrator may determine whether the batch encryption process should re-encrypt existing data values or only encrypt new data values. In this way, the dataset can be updated and re-encrypted repeatedly to maintain data security as data values are updated and changed.

Alternative embodiments may proceed according to a single EFC use case. In these embodiments, the encryption control module may be defined according to the record conditions of a particular EFC. That is, a particular EFC may be defined for a particular column in a data table. The particular EFC may have various record conditions that are associated with unique encryption keys. In this way, as the record conditions are evaluated (e.g., according to the filters that make up each record condition) the data value may be encrypted according to the encryption control module of the record condition. If none of the record conditions are satisfied, the data value may remain unencrypted, and an alert may be generated. Alternatively, the data value may be encrypted according to the encryption control module of the particular EFC. That is, in the presently described embodiment, the particular EFC may act as the fallback encryption technique, such that the data value will be encrypted according to the encryption control module of the particular EFC if the records conditions of the particular EFC are not satisfied. In this way, each data value in a column may be encrypted granularly and deterministically according to multiple record conditions associated with the one EFC.

The presently disclosed techniques are directed to systems and methods for encrypting data in a database. Specifically, a computing system may be configured to retrieve EFCs associated with different encryption control modules. Each EFC may include at least one record condition that may be associated with an encryption control module. EFCs and/or record conditions may be arranged in the computing system's allocated memory cache according to priority. The computing system may evaluate each row or data record of a data table against each record condition of the EFCs. If a particular record condition of an EFC is satisfied, the encryption control module of the EFC may be used to encrypt at least part of the data record. In some embodiments, record conditions may be associated with unique encryption control modules such that the encryption control module of the record condition may be used to encrypt at least part of the data record. If no record conditions of an EFC are satisfied, then the data value may be encrypted according to the encryption control module of the EFC, it may remain unencrypted, or it may be evaluated against the next EFC on the computing system. The disclosed technique for granular and deterministic encryption may end when every data value in a particular column has been encrypted, evaluated against each record condition of a single module EFC, or evaluated against every defined EFC. In some embodiments, a parent EFC with no distinct record condition may be configured to function as a catch all for encrypting all data values that do not satisfy the record conditions of the other EFCs. Alternatively, the EFC may itself act as a fallback encryption control module in embodiments where a single EFC is assigned to each column. These encryption techniques provide extensive flexibility because each data record may be fully or partially encrypted according to information existing in other data tables. Moreover, multiple sets of EFCs may be defined for different columns. In this way, the disclosed method may result in a fully encrypted data table.

Technical effects of the disclosed techniques include encrypting data values with specified encryption keys responsive to information associated with the data value meeting predefined conditions. Accordingly, multiple data values in a single column of a data table may be encrypted with different encryption control modules. Resultingly, an accessor may be able to decrypt and view a subset of data values in a data column while being restricted from viewing others. Storing the EFCs in allocated memory permits this deterministic encryption method to occur in a time and resource efficient manner. Moreover, caching EFCs in a prioritized order prevents conflicting encryption keys being applied to one data value.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method, comprising:
receiving a dataset comprising a plurality of data entries;
determining that a first data entry of the plurality of data entries satisfies a condition associated with a first encryption field configuration of a plurality of encryption field configurations, wherein each encryption field configuration defines a condition and one or more first characteristics of encryption when the condition is satisfied; and
in response to the determining that the first data entry of the plurality of data entries satisfies the condition associated with the first encryption field configuration, encrypting the first data entry based on the one or more first characteristics of encryption associated with the first encryption field configuration.

2. The method of claim 1, comprising:
determining that a second data entry of the plurality of data entries does not satisfy the condition associated with the fist encryption field configuration,
in response to determining that the second data entry does not satisfy the condition associated with the first encryption field configuration, determining that the second data entry of the plurality of data entries satisfies a condition associated with a second encryption field configuration; and
in response to the determining that the second data entry of the plurality of data entries satisfies the condition associated with the second encryption field configuration, encrypting the second data entry based on one or more second characteristics of encryption associated with the second encryption field configuration.

3. The method of claim 1, comprising:
populating a cache comprising the plurality of encryption field configurations.

4. The method of claim 1, wherein the first encryption field configuration associated is stored in a first allocated memory position of a cache and a second encryption field configuration is stored in a second allocated memory position of the cache.

5. The method of claim 4, comprising:
receiving a second data entry of the plurality of data entries;
retrieving the first encryption field configuration from the first allocated memory position in the cache;
determining that the second data entry satisfies the condition associated with the first encryption field configuration; and
in response to the determining that the second data entry satisfies the condition associated with the first encryption field configuration, encrypting the second data entry based on the one or more first characteristics of encryption associated with the first encryption field configuration.

6. The method of claim 1, wherein the condition associated with the first encryption field configuration references an additional data entry from an additional dataset.

7. The method of claim 1, wherein first condition associated with the first encryption field configuration is based on an access privilege assigned to a profile accessing the dataset.

8. A system, comprising:
a processor; and
a memory, accessible by the processing circuitry, and storing instructions that, when executed by the processing circuitry, cause the processing circuitry to perform operations comprising:
receiving a dataset comprising a plurality of data entries;
determining that a first data entry of the plurality of data entries satisfies a condition associated with a first encryption field configuration of a plurality of encryption field configurations, wherein each encryption field configuration defines a condition and one or more first characteristics of encryption when the condition is satisfied; and
in response to the determining that the first data entry of the plurality of data entries satisfies the condition associated with the first encryption field configuration, encrypting the first data entry based on the one or more first characteristics of encryption associated with the first encryption field configuration.

9. The system of claim 8, wherein the condition of the first encryption field configuration comprises a plurality of filters.

10. The system of claim 9, wherein the plurality of filters of the condition of the first encryption field configuration are combined using one or more logic operations.

11. The system of claim 9, wherein a first filter of the plurality of filters of the condition of the first encryption field configuration references an additional data entry from an additional dataset.

12. The system of claim 9, wherein at least one filter of the plurality of filters of the condition of the first encryption field configuration is based on an access privilege assigned to a profile accessing the dataset.

13. The system of claim 8, wherein the memory stores a cache comprising the plurality of encryption field configurations.

14. The system of claim 13, wherein the first encryption field configuration is stored in a first allocated memory position of the cache and a second encryption field configuration is stored in a second allocated memory position of the cache.

15. A non-transitory, computer readable medium comprising instructions that, when executed by processing circuitry, cause the processing circuitry to perform operations comprising:
receiving a dataset comprising a plurality of data entries;
determining that a first data entry of the plurality of data entries satisfies a condition associated with a first encryption field configuration of a plurality of encryption field configurations, wherein each encryption field configuration defines a condition and one or more first characteristics of encryption when the condition is satisfied; and
in response to the determining that the first data entry of the plurality of data entries satisfies the condition associated with the first encryption field configuration, encrypting the first data entry based on the one or more first characteristics of encryption associated with the first encryption field configuration.

16. The non-transitory, computer readable medium of claim 15, comprising:
determining that a second data entry of the plurality of data entries does not satisfy the condition associated with the first encryption field configuration,
in response to determining that the second data entry does not satisfy the condition associated with the first encryption field configuration, determining that the second data entry of the plurality of data entries satisfies the condition associated with a second encryption field configuration; and
in response to the determining that the second data entry of the plurality of data entries satisfies the condition associated with the second encryption field, encrypting the second data entry based on the one or more characteristics of encryption associated with the second encryption field configuration.

17. The non-transitory, computer readable medium of claim 16, wherein:
the first encryption field configuration is stored in a first allocated memory position in a cache and the second encryption field configuration is stored in a second allocated memory position in the cache.

18. The non-transitory, computer readable medium of claim 17, wherein a condition of an encryption field configuration is comprised of one or more filters.

19. The non-transitory, computer readable medium of claim 17, wherein a condition of an encryption field configuration of the plurality of encryption field configurations is configured to be satisfied for each data entry of the plurality of data entries.

20. The non-transitory, computer readable medium of claim 19, wherein the encryption field configuration associated with the condition that is configured to be satisfied for each data entry of the plurality of data entries is stored in the last allocated memory position of the cache.
